(19) United States
(12) Patent Application Publication
(10) Pub. No.: US 2021/0390472 A1
(43) Pub. Date: Dec. 16, 2021

(54) Application for data-driven decision workflow with decision forecasting and asynchronous decision making.

(71) Applicant: Hrishikesh Amravatkar, Fremont, CA (US)

(72) Inventor: Hrishikesh Amravatkar, Fremont, CA (US)

(21) Appl. No.: 16/900,994

(22) Filed: Jun. 15, 2020

(51) Int. Cl. G06Q 10/06; G06F 16/954

(52) U.S. Cl. CPC G06Q 10/0637; G06F 16/954

(57) ABSTRACT

A system and method for data-driven decision making through role-based decision workstream, tracking decisions or discussions, streamlined meeting notes, asynchronous & synchronous decision inputs and collaboration integrations. The technique provides a step-by-step workflow for creating a decision or discussion template along with an option for anonymous feedback, team voting's for all stakeholders. Also, it helps assign priority, due date, and meeting date to the decision template. The system integrates with multiple notification channels to facilitate data population preemptively in the decision template by the team members. On the meeting day, the system facilitates voting and review of data points and anonymous feedback. The system helps assign status and progress on the decisions. The decision status is communicated and displayed in a holistic view through the platform. The system also provides decision forecasting and risk profile analysis based on previous decisions.

### BACKGROUND OF THE INVENTION

Present invention relates to building a software application and method that helps facilitate decision tracking and decision management workflow in a corporate settings and meetings. The invention helps in managing meetings through data-driven decision workflow. Invention also helps in assigning roles needed for streamlining the meeting and the decision-making process. Invention deals with notifying the stakeholders at appropriate point of decision making and helps in asynchronous decision data inputs before the meeting. Invention also uses machine learning in decision forecasting based on past decisions.

### BRIEF SUMMARY OF THE INVENTION

This invention deals with existing problem of meetings being scheduled and tracked without agenda, focus and well-defined roles. Also, the existing problem of how decisions are not tracked and timeboxed. It also is hard to asynchronously add, approve feedback for the meeting without being present in the meeting. There is no better mechanism to forecast decision based on previous similar decisions. The invention applies workflow with integrations with collaboration tools with mechanism of tracking and defining roles for decision making.

### DETAILED DESCRIPTION OF THE INVENTION

The invention is a web based and mobile based platform. The application streamlines and tracks decision and discussion based on visibility of the particular team member to these meetings. The invention initially helps in creating a template for scheduling meetings with well-defined roles like driver, approver, contributor and informed. The invention also provides option in the template to provide decision or discussion columns needed, and due date associated with decision or discussion, options of voting and anonymous feedback option. The application integrates with email and other collaboration tools to notify the stakeholders regarding their role in the decision-making process. Also allows an option to asynchronously add notes, feedbacks or approve other team members data point before the meeting.

During the meeting, the application provides more comprehensive options to the driver role of the decision template. The driver of the meeting coordinates the meeting by using the application to read or add or update through all the data points contributed by the stake holders. The driver of the meeting can also add weights or points to individual data point to get a overall score on different columns for of the decision or discussion. The driver can then choose to call for a team vote and the application provides that option to add names for voting. The driver can also read and go through the anonymous feedbacks of the team members during the meeting. Once that is complete, the application provides option for the driver to choose a decision type, decision status and decision risk profile. If there are different approvers in the decision template, then the driver can request the decision for approval.

Also, based on machine learning the application can provide a risk profile and recommendation based on previous decisions. Once the decision is approved or finalized the particular meeting notes are read only and the application notifies and sends a comprehensive email and handout of the meeting and the data points to all stakeholders.

Application helps track and monitor all decisions based on the team members accessibility. The coordinator can assign timeline and deadline for the resolution or making a decision on a particular topic.

Application also provides analytics on decision or discussions taking place in an organization based on decision status, decision types and decision timelines. Application also helps integrate with other collaboration tools to export decision and discussion data to other platforms.

### The Version of the Invention Discussed Here Includes

1. Web platform

2. Mobile platform.

3. Decision and discussion template with due date, roles, columns, voting option, anonymous feedback option.

4. Third party integrations and mobile notifications.

5. Voting system on individual data points.

6. Asynchronous data input and approving other member data options.

7. Decision approval flow.

8. Decision tracking system.

9. Machine learning based decision forecasting and risk profile system.

### Relationship between the Components

Team members and leadership of a company gets on boarded to the web based (step 1) or mobile (step 2) now called “platform”. Team member creates a decision or discussion template using the product platform which is (step 3). Template creator enters the discussion topic, decision or discussion columns, due date and assigns roles like driver of meeting, approver of the decision or discussion, contributors of the decision and discussion and who need to be informed (Step 3). Using the platform (step 1 or step 2) and using email and other third-party collaboration tools, invite all the key stake holders and members to the platform to fill the details related to the particular decision or discussion. There are notifications and messaging integrations (Step 4), which help in onboarding and updating stake holder team members regarding decision or discussion template (Step 3) on meeting date, decision deadline and topics to fill in data for. If anonymous feedback option is enabled (Step 3), allow team members invited for the decision or discussion to enter the anonymous feedback. Allow team members to approve meeting notes of other team members ahead of the meeting and during the meeting (step 6). During the meeting the drive of the meeting will review through the discussion notes, points on individual data, approvals on individual rows and team votes. Driver updates the decision type, decision status and if there are other approvers for the decision sends the decision for approval (Step 7). During any point of the decision-making process, the decision or discussion status can be tracked (step 8). Once the decisions are finalized, they are ready only and can be recorded for future data analytics and decision forecasting (step 9).

### How the Invention Works

The way web based, and mobile platform works is by providing a decision or discussion template which defines the roles of team members in a decision making process, the data columns that need to be discussions, timeline associated with the decision or discussion , option to add anonymous feedback and option to add team voting. It mandates that there be driver of the meeting, approvers for the decision, contributors for the decisions and team members who need to be informed. The platform also provide option to keep consistent birds eye view of the decisions and discussions those are happening and their statuses in the real time. The platform also provides accountability based on voting and democratized way of making a judgment call on a decision. The platform can also be used for understanding the reasons for a particular decision and the feedback from all the team members that was recorded in the past. The platform also facilitates option to anonymous feedbacks by team members that can help in unbiased feedbacks. The application also provides a record keeping mechanism of all the decisions taken in an organization.

### BRIEF DESCRIPTION OF THE DRAWINGS

The application and its objective will be easier to understand based on the following drawings:

FIG. 1A shows the interactions and roles of individuals who are using the application. Also helps in understanding the flow of interactions with the application.

FIG. 1B is a flow chart of set of instructions and steps that are followed by different stake holders while using the platform and the application. The figure helps understand step by step interactions and process.

FIG. 1C is the decision or discussion template which is created as the first step of the application. Provides visibility into all the data fields.

FIG. 1D is the actual step where the participants vote and enter information. And the decision driver takes a final call.

### DETAILED DESCRIPTION OF THE DRAWINGS

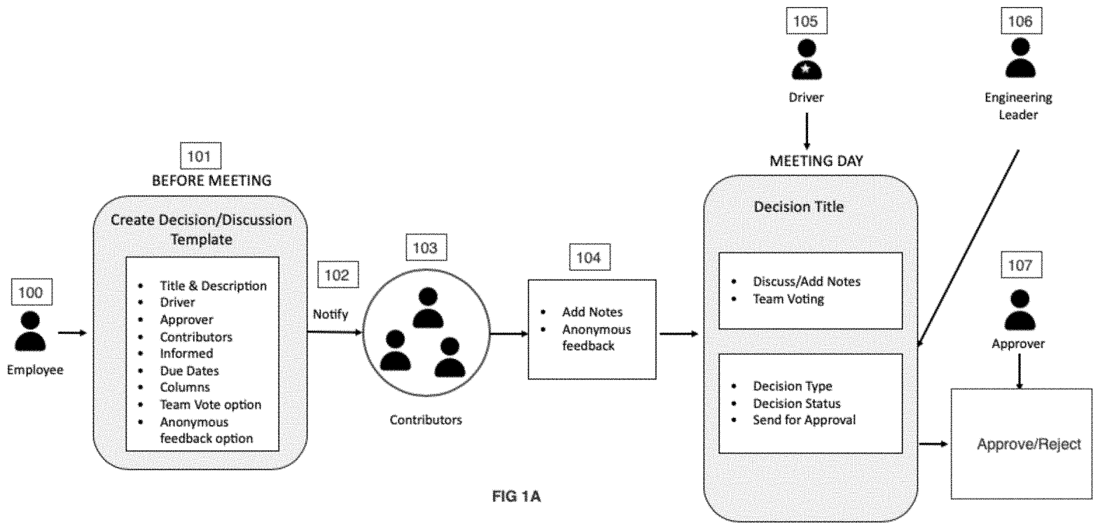

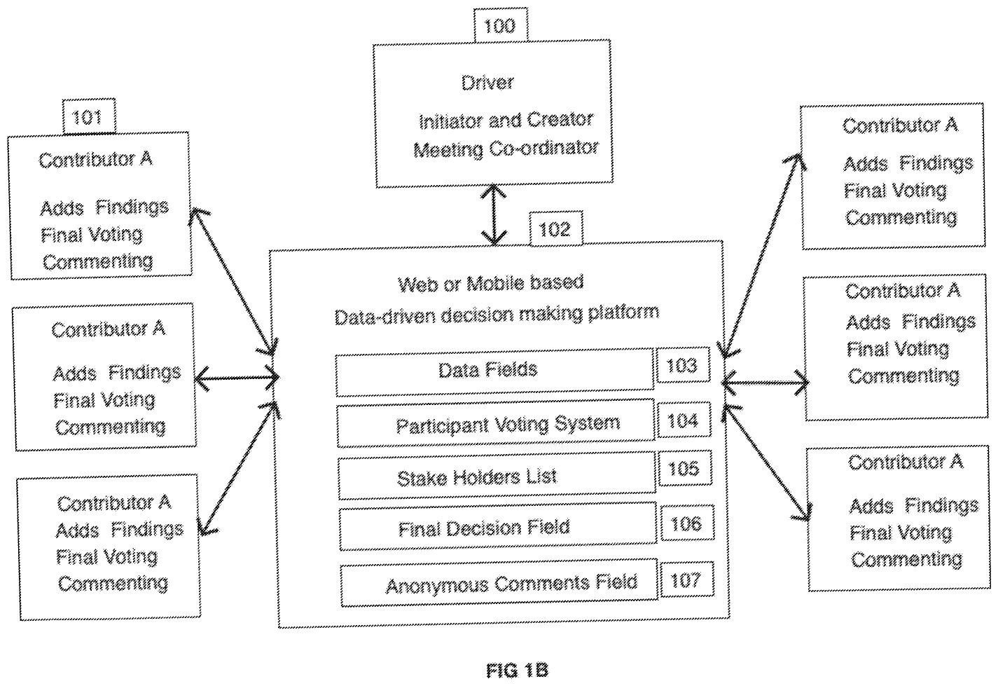

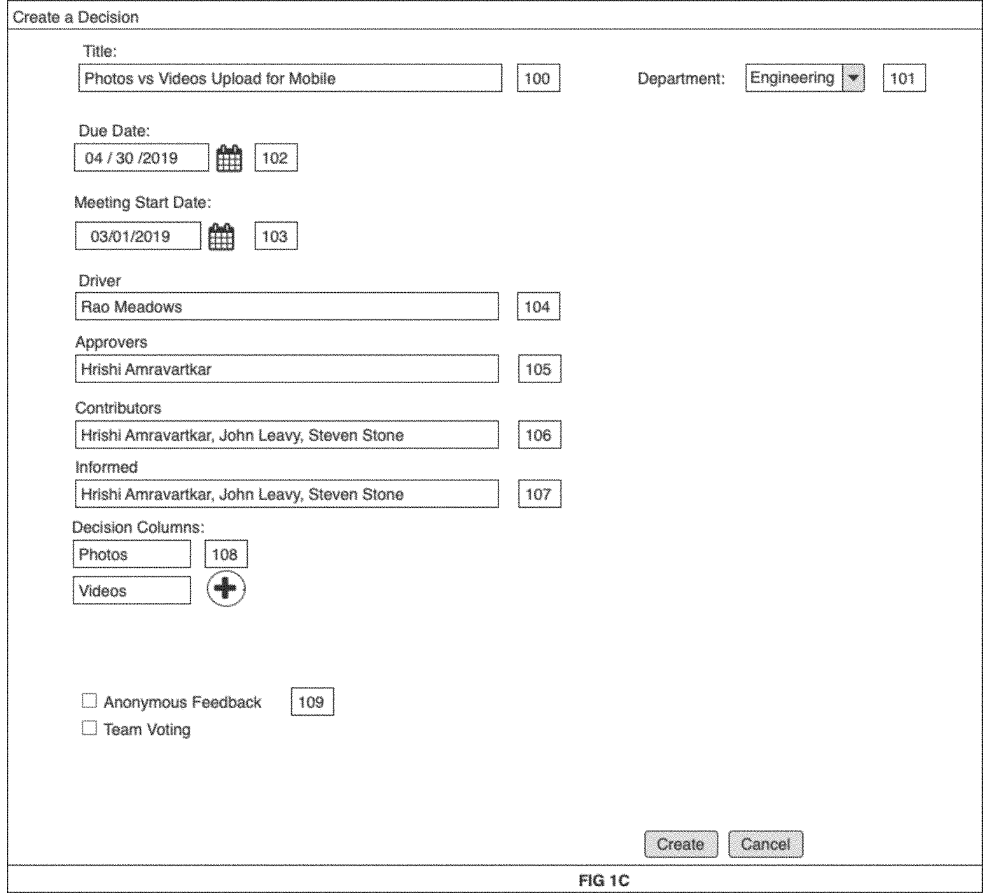

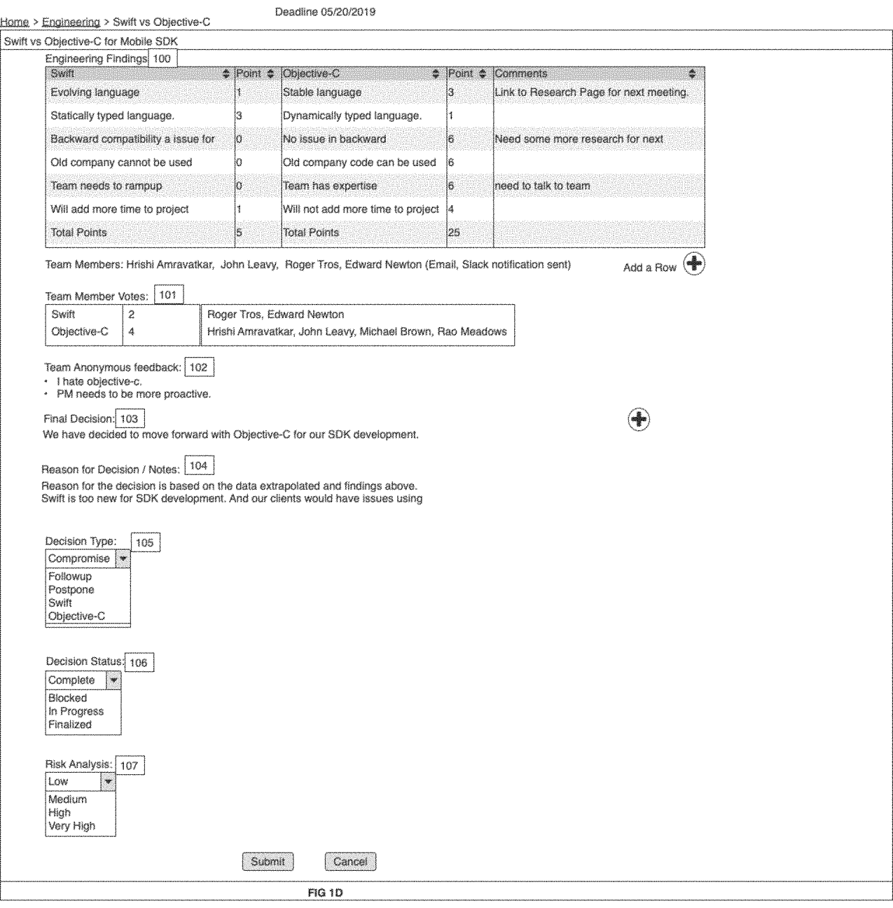

FIG. 1A explains the roles of the stakeholders involved in the application with their operations during different stages of the application. 100 of the FIG. 1A describes the role employee who can create a decision or discussion template on the platform. 101 of the FIG. 1A describes the template fields that the employee creates which includes title, description, assignment of roles like driver, approver, contributor, informed, assigning due date, assigning columns needed for the decision or discussion, option to enable team voting and option for anonymous feedback. The employee assigned members to the roles. 102 of FIG. 1A explains the notification sent through email and other notification channels to the members associated with the decision or discussion template role. 103 of FIG. 1A describes the role of contributors who can asynchronously add their notes, anonymous feedback using the platform which is explained in 104 of FIG. 1A. 105 of FIG. 1A explains the role of the driver and the display of the driver on the day of the meeting. The driver can review all the comprehensive notes and feedbacks from all the contributors. Also, driver can choose to update the decision status, decision type and if there are difference approvers for the decision or discussion, send the current draft to for approval. 106 of FIG. 1A describes role of leadership who have visibility to this decision or discussion to be able to consistently oversee the status of the decision or discussion. 107 of FIG. 1A describes the role of the approver of the decision who can approve or reject the decision or discussion. Once approved the decision is read-only, if rejected the decision is sent back to the draft mode for further discussion by the team.

FIG. 18 explains about the interactions between multiple participants concurrently and the software application. Also, FIG. 18 is an illustration of the roles and responsibility of the participants. 100 of the FIG. 18 describes the role of driver of the draft of the decisions to me made. 100 of FIG. 18 shows the interaction with the web based or mobile platform 102. The platforms main job is to provide framework for data driven decision making with involvement of all the stake holders. The main components of the platform 102 includes, entering the data fields or topics which need to be discussed 103. A mechanism for participants to vote on points during the discussion 104. A mechanism to add and notify all the stake holders using email, mobile notification and other integration with collaboration tools. A record of what stage the decision is at 106. A feature for participants to provide anonymous feedbacks 107. Once a draft is created participants 101 are allowed to add new findings to the platform. 101 contributors are allowed to add anonymous feedbacks. Later contributors are allowed to add final votes on the discussion points on the platform 102 during the meeting.

FIG. 1C illustrates the sample template that application uses to make a decision or discussion draft by an employee who takes the initiative. The template consists of following fields inside the application. 100 is the title of the decision. 101 is the department where this decision is relevant. 102 is the due date for this decision. 103 is the initial meeting date that is set. 104 is the assignment of the driver who needs to coordinate this meeting. 105 is the members who will need to approve the decision. 106 is the list of members who are contributors for the decision-making process. 107 is an optional field which defines the members who need to be informed about the status of the decision. 108 is the columns those need to be discussed, you can add as many columns as possible. 109 is the options like Anonymous feedback and Team voting those are allowed for participants.

FIG. 1D illustrates an example of comprehensive view which is presented by the driver role during the meeting date. 100 are all the findings those are added by all the contributors and participants before or during the meeting. Driver enters a points based on consensus with all the meeting participants on individual rows. 101 is the final vote based on the topics by participants and their names are listed. 102 are the anonymous feedbacks those are provided before the meeting. 103 is the final decision that the coordinator or the owner decides to take based on the data available. 104 is the reason for the decision added with notes. 105 is the type of decision that was taken. 106 is the status of the decision. And 107 is the risk profile of the decision. If the decision or discussion has approvers then the decision is sent for approval process, otherwise the decision can be updated with the current state decided by the driver. All this data is stored in the database and once a decision is finalized are immutable and are available for future reference, analytics, data mining and forecasting.

1. A method of for streamlining meetings using data driven decision workflow.

2. The method of claim 1, where in roles for the decision or discussion are assigned.

3. The method of claim 1, wherein notifying the stakeholders regarding decisions or discussion.

4. The method of claim 1, wherein on the meeting date actions.

5. A website and mobile service which provides holistic view on employee decisions or discussions and respective due dates.
